(19) United States
(12) Patent Application Publication
(10) Pub. No.: US 2025/0178616 A1
(43) Pub. Date: Jun. 5, 2025

(54) COMPUTER-IMPLEMENTED METHOD FOR DETERMINING A CAUSE OF FAILURE OF A FAILURE OF A MANUFACTURED VEHICLE, SYSTEM, COMPUTER PROGRAM AND COMPUTER READABLE MEDIUM

(71) Applicant: ZF Friedrichshafen AG, Friedrichshafen (DE)

(72) Inventor: Jörg Schulz, Berne (DE)

(73) Assignee: ZF Friedrichshafen AG, Friedrichshafen (DE)

(21) Appl. No.: 18/969,820

(22) Filed: Dec. 5, 2024

(30) Foreign Application Priority Data
Dec. 5, 2023 (DE) 10 2023 212 208.1

(51) Int. Cl. B60W 50/02

(52) U.S. Cl. CPC B60W 50/0205; B60W 2050/021

(57) ABSTRACT

A computer-implemented method for determining a cause of a failure for a fault in a manufactured vehicle includes comparing utilization data with production data pertaining to the manufactured vehicle, where at least one measured value of the utilization data is compared with a specified permitted range of the production data. If the measured value is outside the specified permitted range a fault report is determined and is associated with the manufactured vehicle. The production data, the utilization data, and the fault report associated with the manufactured vehicle are compared with production data, utilization data, and fault reports pertaining to reference vehicles, where each fault report pertaining to a reference vehicle is associated with a cause of failure, and a failure cause is determined with reference to the comparison. A system and computer program product are also disclosed.

### RELATED APPLICATIONS

This application claims the benefit of and right of priority under 35 U.S.C. § 119 to German Patent Application no. 10 2023 212 208.1, filed on 5 Dec. 2023, the contents of which are incorporated herein by reference in its entirety.

### FIELD OF THE DISCLOSURE

The present invention relates to a method for determining a cause of a failure in a faulty vehicle.

### BACKGROUND

Methods for determining a cause of a failure in a faulty vehicle are known from the prior art.

To improve the comfort of the user of a vehicle, the complexity of the structure of components of vehicles and also the structure of the vehicles themselves is increasing continually, for example due to an increasing electrification and interconnectedness of vehicles. In general, it is desirable for the causes of failure in vehicles to be able to be identified and eliminated in good time.

### SUMMARY

It is therefore the purpose of the present invention to identify the causes of failure in vehicles in good time so that the causes can be eliminated promptly.

According to a first aspect of the invention, the objective is achieved by a computer-implemented method having the features disclosed herein. The method is provided for determining a cause of failure for a fault in a vehicle. The method comprises the following steps: determination of manufacturing data that represent the production of the vehicle and are associated with the manufactured vehicle; determination of utilization data that represent the utilization of the manufactured vehicle and are associated with the manufactured vehicle; and comparison of the utilization data associated with the manufactured vehicle with the manufacturing data associated with the manufactured vehicle, wherein at least one measured value of the utilization data is compared with a specified permitted range of the production data so that if the measured value is outside the specified permitted range a fault report associated with the measured value and the specified permitted range is determined. The fault report is associated with the manufactured vehicle. Comparison of the production data associated with the manufactured vehicle, the utilization data associated with the manufactured vehicle and the fault report associated with the manufactured vehicle, with production data associated with reference vehicles, utilization data associated with reference vehicles and fault reports associated with reference vehicles, wherein each fault report associated with a reference vehicle is associated with a cause of failure. Determination of a cause of failure for the fault report associated with the manufactured vehicle with reference to the comparison.

In the context of the invention, the term “reference vehicle” includes all the components which, put together, make up the reference vehicle.

Thus, production data are determined which represent the manufacturing of the vehicle and are associated with the manufactured vehicle. In the context of the present invention the vehicle is also called the manufactured vehicle. The production data associated with the manufactured vehicle include, for example, dimensions of components of the manufactured vehicle. The dimensions of the components of the manufactured vehicle are determined, for example, from coordinate values detected with a coordinate measuring instrument. Furthermore, the production data include for example a mass of every component of the components of the manufactured vehicle. The mass of each component is determined for example with the help of a weighing machine. Due to production variables, several components of the same type may differ slightly from one another for example in their dimensions and/or their mass and/or other parameters, but within acceptable tolerances, even if the dimensions and/or masses and/or other parameters desired in a plurality of components of the same type should be identical. With the help of the production data, in particular the design of the geometry of the components, the tolerances of the components and the scatter from one component to the next can be taken into account. Moreover, the production data for each component can contain information about other components of the vehicle, in particular about components that co-operate with the component concerned. For example, the production data for a gearwheel may contain information about another gearwheel which meshes with the gearwheel. Thus, with the help of the production data the influences of adjacent components and/or interfaces can be taken into account. For example, the production data contain information about the manufacturer of the manufactured vehicle, the model range of the manufactured vehicle, the equipment line of the manufactured vehicle, the production period of the manufactured vehicle, and/or the transmission installed in the manufactured vehicle.

It has also already been said that utilization data are determined, which represent the utilization of the manufactured vehicle and are associated with the manufactured vehicle. The utilization data are, for example, time data, temperature data, pressure data, temperature variations over time determined from the time and temperature data, and/or counter data which describe how often a particular process has been carried out or has taken place, such as the number of times a reference temperature has been exceeded, the number of times the temperature has fallen below a reference value, the number of times a pressure has exceeded a reference pressure or the number of times the pressure has fallen below a reference value. For example, the manufactured vehicle contains a detection unit which records times and temperatures, such as the temperature of the surroundings of the manufactured vehicle, and/or pressures. With the help of the utilization data, therefore, aging of the components of the vehicle and/or wear of the components of the vehicle over their operational time and/or external environmental influences can be taken into account. Furthermore, the utilization data can include rotation speed information, gearshift information, acceleration information or speed information. The detection unit of the vehicle can detect, for example, rotation speeds, gearshifts, accelerations of the vehicle, in particular a driving style evaluation of the acceleration behavior of the vehicle, speeds of the vehicle, the number of kilometers covered by the vehicle and/or an orientation of the vehicle. Thus, with the help of the utilization data the influence of the customer and/or of the applications the vehicle is used for can be taken into account. Moreover, the utilization data for each component can contain information about other components that co-operate with the component concerned. For example, the utilization data for a gearwheel can contain information about another gearwheel that meshes with the gearwheel. Thus, with the help of the utilization data the influences of adjacent components and/or interfaces can be taken into account.

Furthermore, it has already been described that the utilization data associated with the manufactured vehicle are compared with the production data associated with the manufactured vehicle, wherein at least one measured value of the utilization data is compared with a specified permitted range of the production data. The utilization data of the manufactured vehicle preferably include one or more measured values, such as the temperature of the hydraulic oil and the production data of the manufactured vehicle preferably contain one or more specified permitted ranges, such as a range that is permissible for the temperature of the hydraulic oil.

If the measured value is outside the specified permitted range, a fault report associated with the measured value and the specified permitted range is generated. In the use of the manufactured vehicle in the example described, the temperature of the hydraulic oil and the specified permitted range for it are compared, and if the temperature of the hydraulic oil is outside the specified permitted range, for example in excess of a permitted maximum temperature that forms the upper limit of the permitted temperature range, then a fault report associated with the temperature and the specified permitted temperature range, such as ABCD1234 is generated. Preferably, for each measured value and for each specified permitted range a fault report is provided. Preferably, a string of characters is assigned to each fault report.

As has also already been described, the fault report is associated with the manufactured vehicle. In the manufactured vehicle so long as no measured value is or has been outside a corresponding permitted range, no fault report is associated with the manufactured vehicle. As soon as in the manufactured vehicle a measured value is outside a corresponding permitted range, the corresponding fault report is generated and associated with the manufactured vehicle. To begin with, no fault report or one or more than one fault report can get and/or be associated with the manufactured vehicle.

As has also already been described, the production data associated with the manufactured vehicle, the utilization data associated with the manufactured vehicle and the fault report associated with the manufactured vehicle are compared with production data associated with reference vehicles, utilization data associated with reference vehicles and fault reports associated with reference vehicles. Preferably, the production data associated with the manufactured vehicle and the production data associated with the reference vehicles are compared with one another. In addition, the utilization data associated with the manufactured vehicle and the utilization data associated with the reference vehicles are preferably also compared with one another. Furthermore, the fault reports associated with the manufactured vehicle and the fault reports associated with the reference vehicles are preferably also compared with one another.

Preferably, production data associated with each reference vehicle, which represent the production of the corresponding reference vehicle, are associated with the reference vehicle. The production data contain, for example, dimensions of components of the reference vehicle. The dimensions of the components of the reference vehicles are for example determined from coordinate values determined from a coordinate measuring instrument. In addition, the production data include a mass for each of the components of the reference vehicle. The mass of each component is determined for example with the help of a weighing machine. Due to manufacturing variations such as slight variations of the dimensions and/or the mass and/or other parameters, several components of the same type may differ from one another within permissible tolerances even though the desired dimensions and/or masses and/or other parameters should be identical for components of the same type. With the help of the measurement data, in particular the design of the geometry of the components, the tolerances of the components and the scatter from one component to the next can be taken into account. Furthermore, the production data for each component can contain information about other components of each reference vehicle, especially about components that co-operate with the corresponding component. For example, the production data about a gearwheel can contain information about another gearwheel that meshes with the gearwheel. Thus, with the help of the production data the influence of adjacent components and/or interfaces can be taken into account. For example, the production data also contain information about the manufacturer of each reference vehicle, the components in each reference vehicle, the equipment line in each reference vehicle, the production period of each reference vehicle and/or the transmission installed in each reference vehicle.

Preferably, utilization data associated with each reference vehicle, which represent the utilization of the corresponding reference vehicle, are associated with the reference vehicle and constitute part of the entire data set associated with the reference vehicle concerned. The utilization data contain, for example, time data, temperature data, pressure data, temperature variations over time determined from the time and temperature data, pressure variations over time determined from the time and pressure data, which describe how often a particular process has been carried out or has taken place, such as the number of times a reference temperature has been exceeded, the number of times the temperature has fallen below a reference temperature, the number of times a reference pressure has been exceeded or the number of times the pressure fell below the reference pressure. For example, each reference vehicle contains a detection unit which detects times and temperatures, for example the temperature of the surroundings of the corresponding reference vehicle, and/or pressures. Thus, with the help of the utilization data the influence of the customer and/or the application case can be taken into account. Furthermore, the utilization data for each component can contain information about other components of the reference vehicle concerned, in particular about components that cooperate with the corresponding component. For example, the utilization data for a gearwheel can contain information about another gearwheel that meshes with the gearwheel. Thus, with the help of the utilization data the influence of adjacent components and/or interfaces can be taken into account.

The utilization data for each reference vehicle preferably contain one or more measured values, such as the temperature of the hydraulic oil, and the production data for each reference vehicle preferably contain one or more specified permitted ranges, such as a permitted range for the temperature of the hydraulic oil. In the use of each reference vehicle, in this example the temperature of the hydraulic oil is compared with the permitted temperature range and if the temperature of the hydraulic oil is outside the permitted range, for example higher than a permitted maximum temperature which is the upper limit of the permitted temperature range, a fault report associated with the temperature and the permitted temperature range, such as ABCD1234 is generated. Preferably, a fault report is associated with every measured value and every specified permitted range. Preferably, a string of characters such as ABCD1234 is associated with each measured value and each specified permitted range. A corresponding fault report is then associated with every reference vehicle. So long as in a particular reference vehicle no measured value is or has been outside a corresponding permitted range, no fault report is yet associated with the reference vehicle. To begin with, each reference vehicle can get and/or be associated with no fault report, or one, or more than one fault report.

As has already been described, each fault report associated with a reference vehicle is associated with a cause of a failure. Since each fault report associated with a reference vehicle is associated with a cause of a failure, from every fault report associated with a reference vehicle the cause of a failure can be concluded. It is often the case that basically, a plurality of causes is responsible for a fault report. For example, when it is notified that the temperature of the hydraulic oil is outside the permitted temperature range, that may be caused by damage to a seal, a defective pump, a defective temperature sensor, a fault in the operation of the electrical circuitry of the reference vehicle, and/or other causes. The damage to a seal, the defective pump, the defective temperature sensor, the fault in the operation of the electrical circuitry of the reference vehicle, and/or any other cause can be regarded as causes of the fault. For example, the cause of a fault may be determined as the successive replacement of the various components of the reference vehicle. Thus, a failure cause can be determined for every fault report.

As has already been described, with reference to the comparison, a failure cause for the fault report associated with the manufactured vehicle is determined. For example, with reference to the comparison a failure cause, in particular a most-often-occurring failure cause can be determined for the fault report associated with the manufactured vehicle. For example, with reference to the manufacturer of the manufactured vehicle, the model range of the manufactured vehicle, the equipment line of the manufactured vehicle, the production period of the manufactured vehicle and/or the transmission installed in the manufactured vehicle and the fault report pertaining to the manufactured vehicle, a cause of failure and in particular a most-often-occurring failure cause can be determined. With reference to the manufacturer of the manufactured vehicle, the model range of the manufactured vehicle, the equipment line of the manufactured vehicle, the production period of the manufactured vehicle and/or the transmission in the manufactured vehicle, and with reference to the fault report pertaining to the manufactured vehicle, preferably first of all a part-quantity of the reference vehicles are produced, which preferably corresponds to the manufacturer of each reference vehicle of the part-quantity, preferably the model range of each reference vehicle of the part-quantity of reference vehicles and/or preferably the equipment line of each reference vehicle of the part-quantity of reference vehicles corresponds to the equipment line of the manufactured vehicle, and/or preferably the production period of each reference vehicle of the part-quantity of reference vehicles overlaps with the production period of the manufactured vehicle, and/or preferably the model range of the transmission in each reference vehicle of the part-quantity of reference vehicles corresponds to the model range of the transmission in the manufactured vehicle. The part-quantity of reference vehicles is also defined by the fact that preferably the fault report that corresponds to the fault report of the manufactured vehicle is associated with each reference vehicle of the part-quantity of reference vehicles. For the fault report that corresponds to the fault report pertaining to the manufactured vehicle, preferably the failure cause associated with that fault report, in particular a most-often-occurring failure cause, is now determined for the reference vehicles. Preferably, the failure cause now corresponds to the failure cause determined with reference to the comparison for the fault report associated with the manufactured vehicle.

With the help of the production data, utilization data and fault report associated with the manufactured vehicle, and the production data, utilization data, fault reports and failure causes associated with the reference vehicles, failure causes can be determined for certain fault reports. Since a particular failure cause exists or is the most-often-occurring failure cause for a particular fault report in the reference vehicles, it can be assumed that the failure cause is also the existing failure cause in the manufactured vehicle, or that it is at least the most probable cause of failure. Even if the failure cause determined is not the actually existing failure cause, it has been found that with the help of the computer-implemented method, on average failure causes for defects in vehicles can be identified more time-efficiently and thus eliminated more quickly than is the case with methods known from the prior art.

In summary, it can thus be established that with the help of the method, failure causes of faults in vehicles can be identified time-efficiently so that the failure causes can then be eliminated promptly.

In an embodiment, the production data are determined while the vehicle is being manufactured. Since the production data are determined during the manufacture of the vehicle, the production data can be taken into consideration, at least in part, already during the production process.

In an embodiment, the functionality of the manufactured vehicle is restricted with reference to the fault report associated with the manufactured vehicle and/or the failure cause determined with reference to the comparison. Since the functionality of the manufactured vehicle is restricted with reference to the fault report associated with the manufactured vehicle and/or the failure cause determined with reference to the comparison, this ensures that the failure cause giving rise to the fault report does not lead to further failure causes in the vehicle or at least that the probability that the failure cause giving rise to the fault report will lead to further failure causes is reduced. For example, if a tire pressure is too low the speed of the vehicle can be kept lower than a reference speed, whereby the driving safety can be increased.

In an embodiment, with reference to the fault report pertaining to the manufactured vehicle, one or more part-quantities of the production data associated with the reference vehicles, the utilization data associated with the reference vehicles and/or the fault reports associated with the reference vehicles are generated and with reference to the part-quantity or part-quantities the failure cause for the fault report associated with the manufactured vehicle is determined with reference to the comparison. Since the one or more part-quantities are formed first, the comparison can be carried out in a more time-efficient manner.

In an embodiment, the method also comprises the following steps: the determination of production data that represent the production of the reference vehicles and are associated with the reference vehicles, and the determination of utilization data that represent the utilization of the reference vehicles and are associated with the reference vehicles, the assignment of fault reports of the reference vehicles and the association of a failure cause with each fault report associated with a reference vehicle. By assigning a corresponding failure cause to each fault report, the corresponding failure cause for every fault report can be determined efficiently for each reference vehicle. More than one failure cause can be associated with each fault report, so that for example with reference to the number of each failure cause associated with a corresponding fault report it can be determined which failure cause is the most often occurring failure cause for the corresponding fault report. For example, in the case when for a particular fault report for a particular reference vehicle a first failure cause has been determined ten times, a second failure cause has been determined once and a third failure cause has been determined once, it is concluded that the first failure cause is the most often occurring failure cause for the corresponding fault report.

In an embodiment, with reference to the failure cause determined the fault in the vehicle is eliminated. For example, to eliminate the fault in the vehicle a component of the vehicle is replaced. The elimination of the fault can be added to the utilization data pertaining to the manufactured vehicle.

In an embodiment, the fault report associated with the manufactured vehicle, the failure cause associated with the manufactured vehicle and/or the elimination of the fault in the manufactured vehicle is added to the utilization data associated with the manufactured vehicle. Since the fault report associated with the manufactured vehicle, the failure cause associated with the manufactured vehicle and/or the elimination of the fault in the manufactured vehicle are added to the utilization data associated with the manufactured vehicle, that information can be taken into account in further comparisons. Furthermore, in that way the manufactured vehicle can be added to the group of reference vehicles for a further manufactured vehicle, so that the manufactured vehicle is a reference vehicle for the further manufactured vehicle.

Production data, utilization data, fault reports and failure causes which are associated with the manufactured vehicle have already been described. Furthermore, production data, utilization data, fault reports and failure causes which are associated with the reference vehicles have already been described. The production data and the utilization data can in each case be determined at least in part from the manufactured vehicle or from the reference vehicle. In addition, the production and utilization data can in each case be determined at least in part from some other device such as a coordinate-measuring instrument. The fault reports and the failure causes and their association with one another can for example be presented in the form of tables and updated while the computer-implemented method is being carried out. The production data, utilization data, fault reports and failure causes can be transmitted at least in part to the computer-readable medium and/or to the computer-readable medium of the manufactured vehicle from customer portals, Customer Experience (CX) databanks, of manufacturers of the vehicle or the reference vehicles, of breakdown assistance services and/or of a maintenance service and/or of the manufactured vehicle or of the reference vehicles.

The data can be part of a fault databank which is stored on the computer-readable medium and which, in addition to the data, comprises a databank management system. A copy of the fault databank is preferably also stored on the computer-readable medium of the manufactured vehicle. Preferably, the fault databank communicates with further databanks which contain data about machine catalogues, data about failure possibilities and effects analyses (Failure Mode and Effects Analysis, FMEA) or products and processes, and data about product and process investigations. The combination of the fault databank and the further databanks can also be called a fault agent or can form part of the fault agent, such that the fault agent can carry out further analyses with reference to all the existing data. Preferably, all the information represented by the existing data is associated with a fault report so that all the information items represented by the existing data can be associated with one another via the fault reports. This association ensures that components for the production of vehicles and production methods for vehicles can be improved further, whereby the probability of fault occurrence can be reduced.

According to a second aspect of the invention, the stated objective is achieved by a system having the features disclosed herein. The system is provided for determining a failure cause in a vehicle. The system comprises means which are adapted to carry out the steps of the method according to the first aspect. The features, technical effects and/or advantages described in connection with the method according to the first aspect apply at least analogously to the system according to the second aspect of the invention, so that there is no need for any corresponding repetition at this point.

According to a third aspect of the invention, the stated objective is achieved by a computer program having the features disclosed herein. The computer program comprises commands which cause the system according to the second aspect to carry out the steps of the method according to the first aspect. The features, technical effects and/or advantages described in connection with the method according to the first aspect and in connection with the system according to the second aspect of the invention also apply at least analogously to the computer program according to the third aspect of the invention, so that there is no need for any corresponding repetition at this point.

According to a fourth aspect of the invention, the objective is achieved by a computer-readable medium having the features disclosed herein. The computer program according to the third aspect is stored on the computer-readable medium. The features, technical effects and/or advantages described in connection with the method according to the first aspect, in connection with the system according to the second aspect and in connection with the computer program according to the third aspect of the invention also apply at least analogously to the computer-readable medium according to the fourth aspect of the invention, so that there is no need for any corresponding repetition at this point.

### BRIEF DESCRIPTION OF THE DRAWINGS

Further features, advantages and applications of the present invention emerge from the following description of example embodiments and from the figures. All the features described or illustrated, taken alone or in any combination, constitute the object of the invention even independently of their composition in the individual claims or their back-references. In the figures, the same indexes denote the same or similar objects. The figures show:

FIG. 1: A schematic representation of an embodiment of a system according to the invention for determining a failure cause of a fault in a manufactured vehicle, and

FIG. 2: A schematic representation of an embodiment of a computer-implemented method according to the invention for determining a failure cause of a fault in the manufactured vehicle.

### DETAILED DESCRIPTION

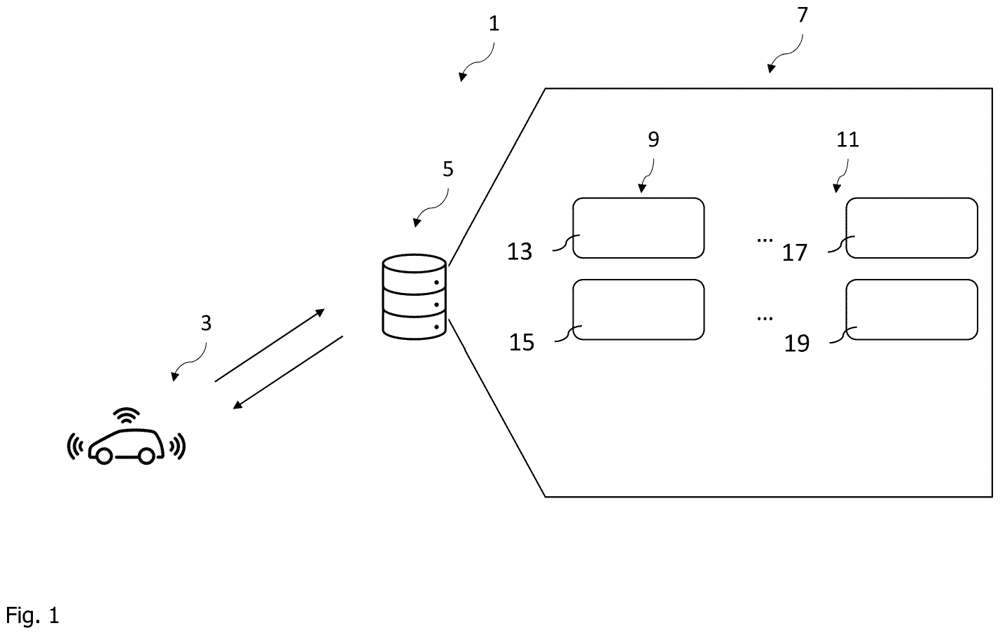

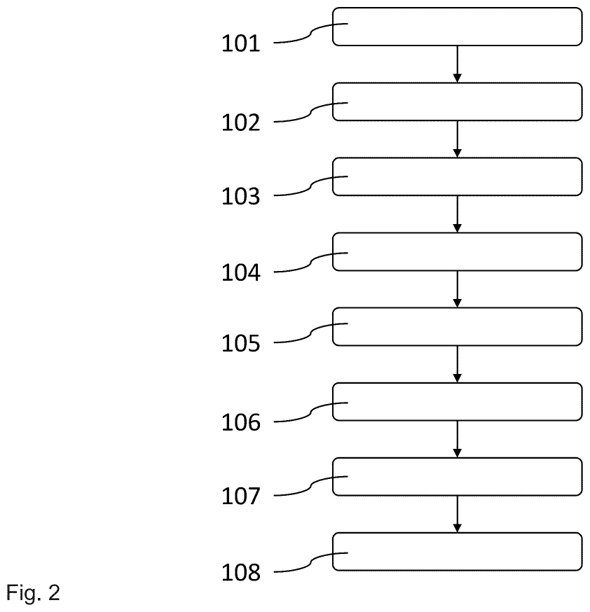

FIG. 1 shows a schematic representation of an embodiment of a system 1 according to the invention for determining a failure cause for a fault in a manufactured vehicle 3, and FIG. 2 shows a schematic representation of an embodiment of a computer-implemented method according to the invention for determining a failure cause for a fault in the manufactured vehicle 3.

The system 1 represented in FIG. 1 is provided for determining a failure cause for a fault in the manufactured vehicle 3. The system 1 comprises means which are adapted to carry out the steps of the method which will be described in detail later. The system comprises the manufactured vehicle 3 and a computer-readable medium 5. On the computer-readable medium 5 is stored a computer program containing commands that cause the system 1 to carry out the steps of the method. In addition to the computer program, data 7 are stored on the computer-readable medium 5. The data 7 include a first data set 9 and further data sets 11. The first data set 9 is associated with the manufactured vehicle 3. Each further data set of the further data sets 11 is associated with a corresponding reference vehicle.

The first data set 9 contains production data 13 pertaining to the manufactured vehicle 3 and that are associated with the manufactured vehicle 3. In addition, the first data set 9 contains utilization data 15 pertaining to the utilization of the manufactured vehicle 3 and that are associated with the manufactured vehicle 3. Each further data set of the further data sets 11 contains determined production data 13 that pertain to the production of a correspond reference vehicle and are associated with the correspond reference vehicle. Furthermore, each further data set of the further data sets 11 contains determined utilization data that pertain to the utilization of the corresponding reference vehicle and are associated with the corresponding reference vehicle. The production data 17 and the utilization data 19 of a dataset of the further data sets 11 are represented as an example in FIG. 1.

In the method represented schematically in FIG. 2, in a first step 101 a number of reference vehicles are produced. While the number of reference vehicle are being produced, production data are determined which pertain to the production of the reference vehicles and are associated with the reference vehicles. As already described, further data sets 11 are provided wherein each dataset of the further data sets 11 is associated with a corresponding reference vehicle. Thus, associated with each reference vehicle are associated production data that pertain to the production of the reference vehicle, which are associated with the reference vehicle and which form part of the further dataset which is associated with the corresponding reference vehicle. The production data contain for example dimensions of components of the reference vehicles. The component dimensions of the reference vehicles are determined for example from coordinate values detected by a coordinate measuring instrument. In addition, the production data include a mass for each component of the components of each reference vehicle. The mass of each component is determined, for example, by a weighing machine. Owing to production variations such as slight dimensional variations several components of the same type may differ slightly from one another in their dimensions and/or their mass and/or other parameters, within permissible tolerances, even if the desired dimensions, mass and/or other parameters should be identical for several components of the same type. With the help of the production data, in particular the design of the component geometry, the tolerance of the components and the scatter between one component and the next can be taken into account. Moreover, the production data for each component can provide information about other components of each reference vehicle, in particular components that co-operate with the component concerned. For example, the production data for a gearwheel can provide information about a further gearwheel that meshes with the gearwheel. Thus, with the help of the production data the influence of adjacent components and/or interfaces can be taken into account. For example, the production data can also include information about the manufacturer of each reference vehicle, the model range of each reference vehicle, the equipment line of each reference vehicle, the production period of each reference vehicle and/or the transmission installed in each reference vehicle.

In a second step 102 of the method, utilization data are determined which represent the utilization of the reference vehicle and which are associated with the reference vehicle. Thus, with each reference vehicle there are associated utilization data that pertain to the utilization of the corresponding reference vehicle, are associated with the corresponding reference vehicle and form part of the further dataset associated with the reference vehicle concerned. The utilization data include for example time data, temperature data, pressure data, temperature variations over time determined from the time data and the temperature data, and/or numerical data which describe how often a particular process has been carried out or has taken place, such as the number of times a reference temperature has been exceeded, the number of times the temperature fell below a reference temperature, the number of times a reference pressure has been exceeded or the number of times the pressure fell below a reference pressure. Each reference vehicle contains for example a detection unit which detects times, temperatures such as the temperature of the surroundings of the corresponding reference vehicle, and/or pressures. Thus, with the help of the utilization data aging of the components of each reference vehicle and/or the wear of the components of each reference vehicle over their operational time, and/or external environmental influences can be taken into account. Furthermore, the utilization data can for example contain rotation speed data, gearshift data acceleration data or speed data. The detection unit in each reference vehicle can for example determine rotation speeds, gearshifts and accelerations of the corresponding reference vehicle, in particular a driving style evaluation of the acceleration behavior of the corresponding reference vehicle, speeds of the corresponding reference vehicle, the number of kilometers covered by the corresponding reference vehicle and/or an orientation of the corresponding reference vehicle. Thus, with the help of the utilization data the influence of the customer and/or of the application case can be taken into account. Moreover, the utilization data for each component can provide information about other components of the corresponding reference vehicle, in particular about components that co-operate with the corresponding component. For example, the utilization data about a gearwheel can provide information about another gearwheel that meshes with the gearwheel. Thus, with the help of the utilization data the influence of adjacent components and/or interfaces can be taken into account.

For each reference vehicle, the first step 101 of the method is carried out first and the second step 102 is then carried out, wherein the first method step 101 and the second method step of different reference vehicles can overlap in time, or the second method step 102 for a first reference vehicle can be carried out before the first method step 101 for a second reference vehicle.

In a third step 103 of the method, fault reports are associated with the reference vehicles. Preferably the utilization data for each reference vehicle include one or more measurement values, such as the temperature of the hydraulic oil, and the production data for each reference vehicle preferably include one or more specified permitted ranges, such as a temperature range that is permissible for the hydraulic oil. During the use of each reference vehicle, in this example the temperature of the hydraulic oil is compared with the specified permitted temperature range, and if the temperature of the hydraulic oil is outside the permitted range, for example above an acceptable maximum temperature that forms the upper limit of the permitted temperature range, a fault report associated with the temperature and the permitted temperature range, such as ABCD1234, is determined. A fault report is preferably provided for each measured value and each specified permitted range. Preferably, a string of characters such as ABCD1234 is associated with every fault report. A corresponding fault report is then associated with each reference vehicle. So long as in a particular reference vehicle no measurement value is or has been outside a corresponding permitted range, no fault report is yet associated with the reference vehicle. As soon as in a particular reference vehicle a measurement value is outside a corresponding permitted range, the corresponding fault report is associated with the reference vehicle concerned. Each reference vehicle can have and/or can get one or more than one fault report associated with it.

Often, more than one cause may basically be responsible for a fault report. For example, if it is determined that the temperature of the hydraulic oil is outside the permitted temperature range, this can be due to a damaged seal, a defective pump, a defective temperature sensor, a fault in the functioning of the electric circuitry of the reference vehicle, and/or other causes. The damaged seal, defective pump, defective temperature sensor, fault in the functioning of the electric circuitry of the reference vehicle, and/or any other causes can then be regarded as failure causes. The failure cause can for example be determined by successive replacement of the various components of the reference vehicle. Thus, a failure cause can be determined for each fault report.

In a fourth method step 104 a failure cause is assigned to every fault report associated with a reference vehicle. By assigning a corresponding failure cause to each fault report, for each reference vehicle the corresponding failure cause for each fault report can be determined in an efficient manner. More than one failure cause can be assigned to each fault report, so that for example with reference to the number of each failure cause for a corresponding fault report it can be determined which is the most-often-occurring failure cause for the fault report concerned. For example, in the case when for a particular fault report for a particular reference vehicle a first failure cause has been determined ten times, a second failure cause has been determined once and a third failure cause has been determined once, it can be concluded that the first failure cause is the one that occurs most often for the corresponding fault report.

In a fifth method step 105, production data 13 are determined, which represent the production of the manufactured vehicle 3 and are associated with the manufactured vehicle 3. The production data 13, for example, include dimensions of components of the manufactured vehicle 3. The dimensions of the components of the manufactured vehicle 3 are for example determined from coordinate values detected by a coordinate measuring instrument. Furthermore, the production data 13 include, for example, a mass for each component of the components of the manufactured vehicle 3. The mass of each component is determined, for example, by means of a weighing machine. Due to production variables, several components of the same type can vary slightly within permitted tolerances of their dimensions, their mass and/or other parameters, even though the desired dimensions, mass and/or other parameters should be identical for several components of the same type. With the help of the production data 13, in particular the design of the geometry of the components, the tolerances of the components and the scatter between one component and the next can be taken into account. Moreover, the production data 13 for each component can provide information about other components of the vehicle 3, in particular about components which co-operate with the corresponding component. For example, the production data 13 about a gearwheel can include information about another gearwheel which meshes with the gearwheel concerned. Thus, with the help of the production data 13 the influences of adjacent components and/or interfaces can be taken into account. For example, the production data 13 also include information about the manufacturer of the manufactured vehicle 3, the model range of the manufactured vehicle 3, the equipment line of the manufactured vehicle 3, the production period of the manufactured vehicle 3 and/or the transmission installed in the manufactured vehicle 3.

The production data 13 are determined while the vehicle 3 is being manufactured. Since the production data 13 are determined while the vehicle 3 is being manufactured, the production data 13 can at least in part already be considered for evaluation even during the production process.

In a sixth method step 106 utilization data 15 are determined, which pertain to the utilization of the manufactured vehicle 3 and are associated with the manufactured vehicle 3. The utilization data 15 include for example time data, temperature data, pressure data, temperature variations over time determined from the time data and the temperature data, and/or numerical data which describe how often a particular process has been carried out or taken place, such as the number of times a reference temperature has been exceeded, the number of times the temperature fell below a reference temperature, the number of times a reference pressure has been exceeded or the number of times the pressure fell below a reference pressure. The manufactured vehicle 3 contains for example a detection unit which detects times, temperatures such as the temperature of the surroundings of the manufactured vehicle 3, and/or pressures. Thus, with the help of the utilization data 15 the aging of components of the manufactured vehicle 3 and/or the wear of components of the manufactured vehicle 3 over their operational time, and/or external environmental influences can be taken into account. In addition, the utilization data 15 can for example contain rotation speed data, gearshift data, acceleration data or speed data. The detection unit of the manufactured vehicle 3 can for example determine rotation speeds, gearshifts, accelerations of the manufactured vehicle 3, in particular a driving style evaluation of the acceleration behavior of the vehicle 3, speeds of the vehicle 3, the kilometer distances covered by the vehicle 3 and/or an orientation of the vehicle 3. Thus, with the help of the utilization data 15 the customer's influence and or the application case can be taken into account. Furthermore, for each component the utilization data 15 can provide information about other components of the vehicle 3, in particular about components which co-operate with the corresponding component. For example, the utilization data 15 for a gearwheel can provide information about another gearwheel which meshes with the gearwheel. Thus, with the help of the utilization data 15 the influence of adjacent components and/or interfaces can be taken into account.

In a seventh method step 107, the utilization data 15 associated with the manufactured vehicle 3 are compared with the production data 13 associated with the manufactured vehicle 3. At least one measured value of the utilization data 15 is compared with a specified permitted range of the production data 13. The utilization data 15 of the manufactured vehicle 3 preferably include one or more measured values such as the temperature of the hydraulic oil, and the production data 13 of the manufactured vehicle 3 preferably include one or more specified permitted ranges, such as a temperature range that is permissible for the temperature of the hydraulic oil. If the measured value is outside the specified permitted range, a fault report associated with the measured value and the specified permitted range is determined. During the use of the manufactured vehicle 3, in the example described the temperature of the hydraulic oil is compared with the permitted temperature range and if the temperature of the hydraulic oil is outside the permitted temperature range, for example above an acceptable maximum temperature that forms the upper limit of the permitted temperature range, then a fault report such as ABCD1234 associated with the temperature and the permitted temperature range is determined. Preferably, for each measured value and each specified permitted range a fault massage is provided. Preferably, a string of characters such as ABCD1234 is associated with every fault report. The fault report is then assigned to the manufactured vehicle 3. So long as in the manufactured vehicle 3 no measured value is or has been outside a corresponding permitted range, no fault report is yet associated with the manufactured vehicle 3. As soon as in the manufactured vehicle 3 a measured value is outside a corresponding permitted range, the corresponding fault report is associated with the manufactured vehicle 3. To begin with, no message, or one, or more than one fault report can be associated with the manufactured vehicle 3.

In an eighth method step 108, the production data 13, the utilization data 15 and the fault reports associated with the manufactured vehicle 3 are compared with production data, utilization data and fault reports associated with reference vehicles. Preferably, the production data 13 associated with the manufactured vehicle 3 and the production data associated with the reference vehicles are compared with one another. In addition, preferably the utilization data 15 associated with the manufactured vehicle 3 and the utilization data associated with the reference vehicles are also compared with one another. Furthermore, preferably the fault reports associated with the manufactured vehicle 3 and the fault reports associated with the reference vehicles are compared with one another. As already described, each fault report associated with a reference vehicle is associated with a failure cause. Since every fault report associated with a reference vehicle is associated with a failure cause, a failure cause can be concluded from every fault report associated with a reference vehicle.

With reference to the comparison, a failure cause is determined for the fault report associated with the manufactured vehicle 3. For example, with reference to the comparison a failure cause, in particular the most-often-occurring failure cause, can be determined for the fault report associated with the manufactured vehicle 3. For example, with reference to the manufacturer of the manufactured vehicle 3, the model range of the manufactured vehicle 3, the equipment line of the manufactured vehicle 3, the production period of the manufactured vehicle 3 and/or the transmission installed in the manufactured vehicle 3 and the fault report pertaining to the manufactured vehicle 3, a failure cause, in particular a most-often-occurring failure cause can be determined. With reference to the manufacturer of the manufactured vehicle 3, the model range of the manufactured vehicle 3, the equipment line of the manufactured vehicle 3, the production period of the manufactured vehicle 3 and/or the transmission installed in the manufactured vehicle 3, and with reference to the fault report pertaining to the manufactured vehicle 3, a part-quantity of the reference vehicles is first produced, such that the manufacturer of each reference vehicle of the part-quantity of reference vehicles corresponds to the manufacturer of the manufactured vehicle 3, the model range of each reference vehicle of the part-quantity of reference vehicles corresponds to the model range of the manufactured vehicle 3, and/or the equipment line of each reference vehicle of the part-quantity of reference vehicles corresponds to the equipment line of the manufactured vehicle 3, and/or the production period of each reference vehicle of the part-quantity of reference vehicles overlaps with the production period of the manufactured vehicle 3, and/or the model range of the transmission in each reference vehicle of the part-quantity of reference vehicles corresponds to the model range of the transmission in the manufactured vehicle 3. The part-quantity of reference vehicles is also defined in that the fault report associated with each reference vehicle of the part-quantity of reference vehicles corresponds to the fault report pertaining to the manufactured vehicle 3. For the fault report of the reference vehicles that corresponds to the fault report of the manufactured vehicle 3, the failure cause associated with that fault report, in particular a most-often-occurring failure cause, is determined for the reference vehicles. This failure cause now corresponds to the failure cause, determined with reference to the comparison, for the fault report associated with the manufactured vehicle 3.

With the help of the production data 13, utilization data 15 and fault report associated with the manufactured vehicle 3 and the production data, utilization data, fault reports and failure causes associated with the reference vehicles, failure causes can be determined for particular fault reports. Since a particular failure cause exists for a particular fault report or is the most-often-occurring failure cause, it can be assumed that this failure cause is also the failure cause present in the manufactured vehicle 3, or at least the most probable failure cause. Even if the failure cause determined is not the actually occurring failure cause, it has been found that with the help of the computer-implemented method on average failure causes for failures in vehicles can be identified more promptly and therefore eliminated more quickly than is the case with methods known from the prior art.

Once the cause of failure for the fault report associated with the manufactured vehicle 3 has been determined with reference to the comparison, with reference to the failure cause determined, the fault in the manufactured vehicle 3 is eliminated.

Before the eighth method step 108, it is possible with reference to the fault report associated with the manufactured vehicle 3 to form one or more part-quantities of the production data, the utilization data and/or the fault reports associated with the reference vehicles. With reference to the one or more part-quantities the failure cause for the fault report associated with the manufactured vehicle 3 can then be determined with reference to the comparison. Since one or more part-quantities are formed first, the comparison can be carried out more time-efficiently.

Furthermore, the fault report, the failure cause and/or the elimination of the fault associated with the manufactured vehicle 3, is then added to the utilization data 15 associated with the manufactured vehicle 3. Since the fault report, the failure cause and/or the elimination of the fault associated with the manufactured vehicle 3 are added to the utilization data 15 pertaining to the manufactured vehicle 3, that information can be taken into account in further comparisons. Moreover, in that way the manufactured vehicle 3 can be added to the group of reference vehicles for another manufactured vehicle 3, so that the manufactured vehicle 3 is a reference vehicle for the other manufactured vehicle 3.

Furthermore, with reference to the fault report associated with the manufactured vehicle 3 and/or the failure cause determined with reference to the comparison, the functionality of the manufactured vehicle 3 is restricted. Since the functionality of the manufactured vehicle 3 is restricted with reference to the fault report associated with the manufactured vehicle 3 and/or the failure cause determined with reference to the comparison, this ensures that the failure cause giving rise to the fault report does not result in further failure causes in the vehicle 3, or at least that the probability of the failure cause giving rise to the fault report will lead to further failure causes, is reduced.

Even though the steps of the method have been described in a particular sequence the present invention is not limited to that sequence. The individual method steps can be carried out in any reasonable sequence, in particular also in part mutually parallel in time.

The computer-readable medium 5 shown in FIG. 1 is arranged outside the manufactured vehicle 3. As already described, the computer program containing commands that cause the system 1 to carry out the method steps is stored on the computer-readable medium 5. In addition to the computer program, the data 7 that comprise the data set 9 and further data sets 11 are also stored on the computer-readable medium 5. All the data relating to the manufactured vehicle 3 are part of the first data set 9, and all the data relating to the reference vehicles are part of the further data sets 11, wherein one of the further data sets 11 is associated with each reference vehicle. To store the data of the first data set 9 on the computer-readable medium 5, the data of the first data set 9 are transmitted to the computer-readable medium 5 and stored therein. To store the data of the further data sets 11 on the computer-readable medium 5, the data of the further data sets 11 are transmitted from the reference vehicles to the computer-readable medium 5 and stored therein.

In addition to the computer-readable medium 5 shown in FIG. 1, the manufactured vehicle 3 also contains a computer-readable medium, which can also be called the computer-readable medium of the vehicle 3. On the computer-readable medium of the vehicle 3 the computer program is stored, or at least those parts of the computer program that contain the commands that cause the system 1 to carry out the steps of the method. In addition to the computer program or at least the parts thereof, the data 7 comprising the first data set 9 and the further data sets 11 are also stored on the computer-readable medium. All the data pertaining to the manufactured vehicle 3 are part of the first data set 9 and all the data pertaining to the reference vehicles are part of the further data sets 11, wherein one data set of the further data sets is assigned to each reference vehicle. To store the data of the first data set 9 on the computer-readable medium of the manufactured vehicle 3, the data of the first data set 9 are transferred section by section from the computer-readable medium 5 to the manufactured vehicle 3, or received section by section by the manufactured vehicle 3, and directly stored therein. To store the data of the further datasets 11 on the computer-readable medium of the manufactured vehicle 3, the data of the further datasets 11 are transferred from the computer-readable medium 5 to the manufactured vehicle 3 and stored therein. In an alternative embodiment of the system 1 according to the invention, the data of the further datasets 11 together are transferred by a server to the manufactured vehicle 3 and stored therein.

In addition to the method steps already described, during the course of the production, maintenance, development or fault elimination of the vehicle 3, with the help of certain verbal commands specialized personnel can request certain visual or acoustic information, such that the visual information is displayed to the specialized personnel on a computer at the servicing shop, the manufacturer or in the context of process and product development. With the help of the verbal commands and the visual or acoustic information the security against faults and the reliability of the vehicle 3 can be increased. For example, the specialized personnel can give the following verbal command: Show me the frequency of all the fault codes XXXYYY from manufacturer A, the model series B, the equipment line C, for the time period AA BB CCCC to DD EE FFFF, with the vehicle transmission D. The frequency of the fault codes XXXYYY from the manufacturer A, the model series B, the equipment line C, during the time period AA BB CCCC to DD EE FFFF and with the transmissions D are then displayed to the specialized personnel on the computer.

In addition, the specialized personnel can for example give the following verbal command: Show me the prevailing environmental temperature, kilometers covered, driving style evaluation, acceleration behavior and the orientation of the vehicle 3 at the time-point when the fault code XXXYYY occurred. The prevailing environmental temperature, kilometers covered, driving style evaluation, acceleration behavior and the orientation of the vehicle 3 at the time-point when the fault code XXXYYY occurred are then displayed to the specialized personnel.

Furthermore, all documentation relevant to the failure cause and the measures to eliminate it, such as so-termed FMEA-Risk Evaluations, test reports, and design interpretations can be displayed.

Finally, the vehicle 3 can be regarded as the prime example of various conditions of vehicle aggregates or vehicle components.

The data 7 shown in FIG. 1 are part of a fault databank which is stored on the computer-readable medium 5, which besides the data 7 also contains a databank management system. A copy of the fault databank is also stored on the computer-readable medium of the manufactured vehicle 3. The fault databank communicates with other databanks, which contain data about machine catalogues, data about possible faults and analyses of their influences (Failure Mode and Effects Analysis, FMEA) on products and processes, and data about product and process investigations. The combination of the databank with other databanks can also be called a fault agent or it can form part of the fault agent, so that with reference to all available data the fault agent can carry out further analyses. Preferably, all information represented by the existing data is assigned to a fault report so that all the information particulars represented by the existing data can be assigned to one another. That association ensures that components for the manufacture of vehicles and vehicle manufacture methods can be further improved, whereby the probability that faults will occur can be reduced.

As a supplement, let it be said that “containing” does not exclude any other element or step, and “one” or “an” does not exclude a plurality. Furthermore, let it be pointed out that features described with reference to one of the above example embodiments can also be used in combination with other features of other example embodiments described above. Indexes used in the claims should not be regarded as having restrictive force.

### INDEXES

1 System
3 Vehicle
5 Computer-readable medium
7 Data
9 First dataset
11 Further datasets
13 Production data in the first dataset
15 Utilization data in the first dataset
17 Production data in a further dataset
19 Utilization data in a further dataset
101 First method step
102 Second method step
103 Third method step
140 Fourth method step
105 Fifth method step
106 Sixth method step
107 Seventh method step
108 Eighth method step

1. A computer-implemented method for determining a cause of failure for a fault in a manufactured vehicle (3), wherein the method comprises the following steps:
determining production data (13) that pertain to the production of the manufactured vehicle (3) and are associated with the manufactured vehicle (3);
determining utilization data that pertain to the utilization of the manufactured vehicle (3) and are associated with the manufactured vehicle (3);
comparing the utilization data (15) pertaining to the manufactured vehicle (3) with the production data (13) pertaining to the manufactured vehicle (3), wherein at least one measured value of the utilization data (15) is compared with a specified permitted range, and determination of a fault report pertaining to the measured value and the specified permitted range,
assigning the fault report to the manufactured vehicle (3);
comparing the production data (13) pertaining to the manufactured vehicle (3), the utilization data (15) pertaining to the manufactured vehicle (3), and the fault report pertaining to the manufactured vehicle (3) with production data pertaining to reference vehicles, utilization data pertaining to reference vehicles, and fault reports pertaining to reference vehicles, wherein a failure cause is associated with every fault report pertaining to a reference vehicle; and
determining a failure cause for the fault report pertaining to the manufactured vehicle (3), with reference to the comparison.

2. The method according to claim 1, wherein the production data (13) are determined during the production of the vehicle (3).

3. The method according to claim 1, comprising restricting the functionality of the manufactured vehicle (3) with reference to the fault report pertaining to the manufactured vehicle (3) and/or with reference to the failure cause determined with reference to the comparison.

4. The method according to claim 1, comprising:
forming, with reference to the fault report pertaining to the manufactured vehicle (3), one or more part-quantities of the production data, utilization data, and/or fault reports pertaining to the reference vehicles; and
determining, with reference to the part-quantity or quantities, the failure cause for the fault report pertaining to the manufactured vehicle (3) with reference to the comparison.

5. The method according to claim 1, wherein the method also comprises the following steps;
determining production data that pertain to the production of the reference vehicles and are associated with the reference vehicles;
determining utilization data that pertain to the utilization of the reference vehicles and are associated with the reference vehicles;
assigning fault reports to the reference vehicles; and
assigning a failure cause to every fault report that pertains to a reference vehicle.

6. The method according to claim 1, comprising eliminating, with reference to the failure cause determined, the fault in the manufactured vehicle (3).

7. The method according to claim 1, comprising adding the fault report pertaining to the manufactured vehicle (3), the failure cause associated with the manufactured vehicle (3), and/or the elimination of the fault in the manufactured vehicle (3) to the utilization data (15) pertaining to the manufactured vehicle (3).

8. A system (1) for determining a cause of a failure of a manufactured vehicle (3) with means that are adapted so as to carry out the steps of the method according to claim 1.

9. A computer program product containing executable code that when executed carries out the steps of the method according to claim 1.

10. (canceled)
